(19) United States
(12) Patent Application Publication
(10) Pub. No.: US 2025/0148494 A1
(43) Pub. Date: May 8, 2025

(54) SYSTEM AND METHODS FOR CONTROLLING ALLOCATION OF DIGITAL RESOURCES

(71) Applicant: Sabdhaswara VARATHARAJAN, Scarborough (CA)

(72) Inventor: Sabdhaswara VARATHARAJAN, Scarborough (CA)

(21) Appl. No.: 18/940,292

(22) Filed: Nov. 7, 2024

Related U.S. Application Data
(60) Provisional application No. 63/597,195, filed on Nov. 8, 2023.

(51) Int. Cl. G06Q 30/0207; G06Q 50/00

(52) U.S. Cl. CPC G06Q 30/0215; G06Q 50/01

(57) ABSTRACT

A computer-implemented method is disclosed. The method includes: receiving, via a first computing device, a first request to process an initial allocation of a first quantity of digital resources to a resource account; providing, to a second computing device associated with the resource account, an indication of a first user action that is required for gaining access to a second quantity of the digital resources, the first user action comprising an upload, via the second computing device, of multimedia data to the computing system; receiving, via the second computing device, a second request to access the second quantity of the digital resources, the second request including at least one multimedia object; in response to determining that the at least one multimedia object satisfies defined criteria: causing the second quantity of the digital resources to be allocated to the resource account; and providing, to the second computing device, an indication of a second user action in connection with the at least one multimedia object that is required for gaining access to a third quantity of the digital resources.

### CROSS-REFERENCE TO RELATED APPLICATION

The present application claims the benefit of priority to U.S. Provisional Patent Application No. 63/597,195 filed on Nov. 8, 2023, the contents of which are incorporated herein by reference.

### TECHNICAL FIELD

The present application relates to resource account management and more particularly, to a system and methods for dynamically controlling allocation of digital resources.

### BACKGROUND

A resource account management system may manage user accounts that are associated with various different types of resources. By way of example, a digital resource account may store resource data associated with digital resources, such as loyalty or reward points, electronic vouchers, virtual currency, digital tokens, or other stored value objects. Digital resources may be acquired by a customer, for example, upon making a purchase from a merchant that administers a loyalty program. When a customer participating in a loyalty program conducts an eligible purchase transaction, a certain quantity of reward points may be allocated to the customer's account within the loyalty program. More generally, a computing system that is adapted for managing resource accounts may be configured to monitor account activity and data and control the allocation of resources to the accounts based on results of the monitoring.

### BRIEF DESCRIPTION OF THE DRAWINGS

Implementations are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for controlling allocation of digital resources to a resource account;

FIG. 4 shows, in flowchart form, another example method for controlling allocation of digital resources to a resource account;

FIG. 5 shows, in flowchart form, an example method for validating requests to allocate digital resources to a resource account;

FIG. 6 shows, in flowchart form, an example method for processing a merchant request to allocate digital resources to a customer;

FIG. 7 shows, in flowchart form, an example method for providing a news feed associated with a digital resource platform; and

FIGS. 8A to 8L show pages of a graphical user interface (GUI) of an example application which may be used for accessing a digital resource platform, in accordance with embodiments of the present disclosure.

Like reference numerals are used in the drawings to denote like elements and features.

### DETAILED DESCRIPTION OF VARIOUS EMBODIMENTS

In an aspect, a computer-implemented method is disclosed. The method includes: receiving, via a first computing device, a first request to process an initial allocation of a first quantity of digital resources to a resource account; providing, to a second computing device associated with the resource account, an indication of a first user action that is required for gaining access to a second quantity of the digital resources, the first user action comprising an upload, via the second computing device, of multimedia data to the computing system; receiving, via the second computing device, a second request to access the second quantity of the digital resources, the second request including at least one multimedia object; in response to determining that the at least one multimedia object satisfies defined criteria: causing the second quantity of the digital resources to be allocated to the resource account; and providing, to the second computing device, an indication of a second user action in connection with the at least one multimedia object that is required for gaining access to a third quantity of the digital resources.

In some implementations, the method may further include causing the first quantity of digital resources to be allocated to the resource account, and the indication of the first user action may be provided to the second computing device in response to detecting completion of the initial allocation.

In some implementations, the defined criteria may relate to multimedia object type and the method further include determining that an object type associated with the at least one multimedia object is an image or a video.

In some implementations, the method may further include providing, via a graphical user interface on the second computing device, a multimedia input request for prompting user input of a selection of a multimedia object to upload to the computing system.

In some implementations, providing the indication of the first user action may include causing display, via a graphical user interface on the second computing device, of at least one user interface element that is selectable for initiating the first user action.

In some implementations, the method may further include generating a unique first token associated with the initial allocation of the first quantity of digital resources to the resource account; providing, to the second computing device, the first token; and validating the second request based on confirming that the second request is associated with the first token.

In some implementations, the second user action may include: a user input of a request to upload, via the second computing device, the at least one multimedia object to a user account associated with the second computing device at a social networking server; or sharing a link associated with the upload to the user account at the social networking server.

In some implementations, the method may further include: determining that the second user action has been initiated; and in response to determining that the second user action has been initiated, causing the third quantity of the digital resources to be allocated to the resource account.

In some implementations, the method may further include causing display, via a graphical user interface on the second computing device, of the at least one multimedia object in association with a public user account.

In some implementations, the method may further include causing display, via a graphical user interface on the first computing device, of the at least one multimedia object in association with a merchant account.

In another aspect, a computing system is disclosed. The computing system includes a processor and a memory coupled to the processor. The memory stores computer-executable instructions that, when executed by the processor, configure the processor to: receive, via a first computing device, a first request to process an initial allocation of a first quantity of digital resources to a resource account; provide, to a second computing device associated with the resource account, an indication of a first user action that is required for gaining access to a second quantity of the digital resources, the first user action comprising an upload, via the second computing device, of multimedia data to the computing system; receive, via the second computing device, a second request to access the second quantity of the digital resources, the second request including at least one multimedia object; in response to determining that the at least one multimedia object satisfies defined criteria: cause the second quantity of the digital resources to be allocated to the resource account; and provide, to the second computing device, an indication of a second user action in connection with the at least one multimedia object that is required for gaining access to a third quantity of the digital resources.

In another aspect, a computer-implemented method is disclosed. The method includes: receiving, via a first computing device, a first request to display a news feed associated with a digital resource platform; obtaining historical multimedia upload data associated with one or more merchants, the historical multimedia upload data including multimedia objects previously uploaded to the digital resource platform by at least one user in exchange for an allocation of digital resources to a first user account associated with the at least one user on the digital resource platform; causing to be displayed, via the first computing device, the news feed including one or more of the multimedia objects; receiving, via a second computing device, a new upload of multimedia data to the digital resource platform in exchange for an allocation of digital resources to a second user account associated with the second computing device; and causing to be displayed, via the first computing device, an updated news feed based on the new upload of multimedia data.

In some implementations, the multimedia objects may comprise images or videos that are associated with at least one merchant having a merchant account on the digital resource platform.

In some implementations, the multimedia objects may comprise images or videos previously uploaded by the at least one user in exchange for the allocation of digital resources to the first user account.

In some implementations, the method may further include determining a feed type associated with the first request, and causing the updated news feed to be displayed may include determining those of the previously uploaded multimedia objects that are available for displaying on news feeds of the feed type.

In some implementations, causing the updated news feed to be displayed may include determining preference data of a user account associated with the first request and identifying multimedia objects for display on the news feed based on the preference data.

In some implementations, causing the updated news feed to be displayed may include determining user engagement data of a user account associated with the first request and identifying multimedia objects for display on the news feed based on the user engagement data.

In some implementations, the method may further include: identifying a user account associated with the first request; determining, based on preference data associated with the user account, recommendations of one or more of the multimedia objects; and providing, to the first computing device, display data for the news feed comprising the recommendations of the multimedia objects.

In some implementations, the display data for the news feed may further include promotional data of products associated with a plurality of merchants on the digital resource platform.

In some implementations, the recommendations of the one or more of the multimedia objects may be determined based on rewards earned history associated with the user account.

In some implementations, the recommendations of the one or more of the multimedia objects may be determined based on user engagement data associated with the user account.

In another aspect, a computing system is disclosed. The computing system includes a processor and a memory coupled to the processor. The memory stores computer-executable instructions that, when executed by the processor, configure the processor to: receive, via a first computing device, a first request to display a news feed associated with a digital resource platform; obtain historical multimedia upload data associated with one or more merchants, the historical multimedia upload data including multimedia objects previously uploaded to the digital resource platform by at least one user in exchange for an allocation of digital resources to a first user account associated with the at least one user on the digital resource platform; cause to be displayed, via the first computing device, the news feed including one or more of the multimedia objects; receive, via a second computing device, a new upload of multimedia data to the digital resource platform in exchange for an allocation of digital resources to a second user account associated with the second computing device; and cause to be displayed, via the first computing device, an updated news feed based on the new upload of multimedia data.

In another aspect, a computer-implemented method is disclosed. The method includes: receiving, via a computing device, a search query; obtaining a set of one or more search results based on performing a search of a database using the search query; determining a display order of displaying the one or more search results, wherein the determining comprises: identifying a first subset of search results that are associated with merchant accounts on a digital resource platform having respective a digital resource allocation program enabled; and setting the display order such that the first subset of search results is displayed with higher priority than search results that are not included in the first subset; and causing the one or more search results to be displayed via the computing device in accordance with the display order.

In some implementations, determining the display order may include: identifying a second subset of search results that are associated with merchant accounts on the digital resource platform that do not have a respective digital resource allocation program enabled; and setting the display order such that the second subset of search results is displayed with higher priority than search results that are not included in the first subset or the second subset and lower priority than search results included in the first subset.

In some implementations, causing the one or more search results to be displayed in accordance with the display order may include causing the computing device to display, on a search user interface, search results associated with higher priority before displaying search results associated with lower priority based on the display order.

In some implementations, the one or more search results may include merchant information associated with the merchant accounts.

In some implementations, at least one of the search results may comprise a link that is associated with a profile page of a corresponding merchant account.

In some implementations, the search results of the first subset may be displayed in a random order or in accordance with defined display criteria.

In some implementations, the search results of the second subset may be displayed in a random order or in accordance with defined display criteria.

In another aspect, a computing system is disclosed. The computing system includes a processor and a memory coupled to the processor. The memory stores computer-executable instructions that, when executed by the processor, configure the processor to: receive, via a computing device, a search query; obtain a set of one or more search results based on performing a search of a database using the search query; determine a display order of displaying the one or more search results, wherein the determining comprises: identifying a first subset of search results that are associated with merchant accounts on a digital resource platform having respective digital resource allocation program enabled; and setting the display order such that the first subset of search results is displayed with higher priority than search results that are not included in the first subset; and cause the one or more search results to be displayed via the computing device in accordance with the display order.

In another aspect, a non-transitory, processor-readable medium is disclosed. The medium stores processor-executable instructions that, when executed by a processor, may cause the processor to perform any one or more of the methods described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example implementations of the present application are not limited to any particular operating system, system architecture, mobile device architecture, server architecture, or computer programming language.

### Dynamic Allocation of Digital Resources to User Accounts

Resource accounts of various types may be managed by an account management system. One of the functions of an account management system may be regulating the allocation of resources to user accounts that are managed by the system. In particular, a resource account management system may dynamically allocate, e.g., transfer, distribute, assign, etc., resources to user accounts based on actions taken by the users in connection with their accounts.

An example of a resource account is a digital resource account, such as a loyalty program account. A customer's loyalty program account may be associated with a loyalty program that is established by a merchant to reward customers for their patronage. When a customer interacts with a merchant's storefront (e.g., a merchant's place of business, merchant website, in-store POS, etc.), digital resources, such as reward points, electronics vouchers, virtual currency, or other forms of stored value, may be allocated to a loyalty program account of the customer. For example, if a customer makes an eligible purchase transaction with a merchant, the customer's loyalty program account may be credited with reward points. The reward points can, in turn, be redeemed for one or more of a plurality of rewards that are available for selection by the customer. The rewards may be in the form of products (e.g., merchandise, gift cards, services, etc.) offered by the merchant and/or third-party entities that are affiliated with the merchant, or they may be exchanged for digital offerings of other loyalty programs.

Loyalty program implementations have traditionally been limited in user engagement and interactivity. A loyalty program may allow participating members to access rewards information which statically indicates rewards that the members are eligible to claim. However, such programs may not support account customization. In particular, traditional computing systems administering loyalty programs are configured to allocate predetermined quantities of digital resources conditioned on a defined set of events, but lack the capacity to dynamically adjust the digital resources which may be allocated to member accounts.

For example, reward points may be allotted to customer accounts in accordance with a defined program policy when customers engage in one or more of a defined set of events (e.g., purchases at participating merchants). The account data, including quantities of accumulated reward points, of the customer accounts may comprise static information which is not adjustable by the computing system that administers the program. In particular, the computing system may not support dynamically allocating resources to customer accounts in response to various different types of user interactions which are not included in the originally defined set of events. As a consequence, updates to account data may require manual input by an administrator, limiting the capacity for real-time adjustment and display of the current account data. Such limitations may make loyalty programs less attractive for participating and prospective members, leading to low redemption rates and, ultimately, less interest in participation by third-party affiliates.

Various solutions for addressing the aforementioned technical challenges associated with resource account management are described in the present disclosure. In an embodiment, the present application discloses a novel solution for managing loyalty programs. More particularly, a digital resource platform that enables real-time management and allocation of rewards (e.g., reward points) to customers is proposed.

The proposed platform maintains user accounts for users that have registered with the platform. The user accounts may include merchant accounts and customer accounts. A merchant account is an account associated with a merchant that uses the platform to, for example, monitor customer interaction events (e.g., purchase transactions, multimedia uploads, etc.), manage their loyalty program(s), and allocate rewards (and more generally, digital resources) to eligible customer accounts. A customer account is an account associated with a customer of one or more merchants that use the platform. A customer can collect rewards from multiple different merchants through their customer account.

A merchant can selectively allocate rewards to specific customers on the platform. An account of a customer that receives rewards is updated to reflect the allocation of the rewards by the merchant. In at least some implementations, the customer may receive a message (e.g., a text message, push notification, etc.) notifying the customer that rewards have been allocated to their account and prompting the customer to claim the rewards. The message may additionally identify a quantity of rewards earned by the customer, the name of merchant/business allocating the rewards, and a redirect link to a page for sign-in/registration for a user account on the platform.

The platform is designed to incentivize customer activity for promoting a merchant's product (i.e., a good or a service). In particular, the platform may process actions of customers when they are logged in to their account and assess whether the customer actions satisfy certain defined criteria. If the customer actions satisfy the criteria, the platform may automatically allocate additional rewards to the customer account.

By way of example, if a customer uploads multimedia (e.g., photo, video, etc.) data that is indicative of a product purchase, service experience, etc. in connection with a merchant, the platform may automatically double the initial quantity of rewards that is allocated by the merchant to the customer. When multimedia data is uploaded to the platform by a customer (e.g., through the customer's account), the platform may be configured to process the multimedia data and determine whether the multimedia satisfies requirements (which may be set by the merchant) for additional rewards. For example, an image may satisfy a merchant's requirements for a doubling of rewards if the image depicts a product that is (1) offered by the merchant (e.g., a product that is included in the merchant's catalogue) and (2) verified to be purchased by the customer who uploads the image.

As another example, if a customer shares content (e.g., photo/video, product review, etc.) relating to a product purchase or service experience on a social media account of the customer, the platform may automatically allocate further additional rewards to the customer's loyalty program account. The shared content may include, for example, a redirect link to the merchant's page and/or the customer's page or feed (or a particular content item on the page/feed) that is provided by the platform. The platform may be configured to process the customer's social media posting data and assess whether the content of a posting satisfies defined requirements for additional rewards. If the platform determines that the content satisfies the requirements, the platform may allocate further additional rewards to the customer's loyalty program account. For example, the platform may automatically triple the initial quantity of rewards that is allocated by the merchant to the customer. The platform may cause the rewards (and more generally, digital resources) to be allocated in real-time to the customer's loyalty program account and/or transferred to a device associated with the customer.

The present application describes a computing system that implements a platform for allocating digital resources. Users of the platform may collect digital resources from a plurality of resource providers. In some embodiments, the computing system may implement a platform for connecting customers (and prospective customers) with merchants offering customer loyalty programs. The platform may support creation and customization of digital resource allocation programs and issuance of digital resources to the platform users.

Disclosed herein are methods for allocating resources to user accounts of a digital resource platform. Users of the platform may obtain digital resources provided by one or more resource providers (e.g., merchants). A user may receive an increase in the quantity of digital resources obtained from a provider, in return for performing one of a defined set of actions. Such actions may include, among others, uploading images (e.g., photos, videos, etc.) depicting the user's interaction with the resource provider. For example, the user interaction may include purchase of a merchant's products, services, etc., and the images of the user interaction may comprise photos or videos that are captured using the user's device. The images may be uploaded, by the user, to a data store associated with the computing system, in exchange for additional digital resources issued by the resource provider to the user. In particular, the computing system dynamically adjusts the quantity of digital resources allocated to the user account on the platform responsive to detecting that the user has performed one of the defined actions.

The uploaded images are then displayed on a user interface associated with the platform. The images uploaded by users become accessible across the platform to a plurality of resource providers and users who either have or do not have an account on the platform. An image uploaded by a user that collects digital resources from a resource provider may be presented, for example, on: a publicly accessible web feed for the platform; a private web feed with limited viewing access (depending on the uploading user's account settings); the uploading user's profile page on the platform; and the profile page of the resource provider who sent, or distributed, the digital resources to the user.

The user may share the images (and/or a hyperlink to the images) from the platform onto their other social media account(s) in exchange for an additional increase in digital resources obtained by the user. In particular, the quantity of digital resources obtained by the user from a resource provider may be further adjusted by the computing system responsive to detecting an upload action in connection with the user's own social media account(s). The user may, for example, share the images as a direct photo/video from the platform onto their social media account, or share a hyperlink from the platform that displays the photo/video onto their social media account. In some implementations, the computing system may automatically mark the content being shared by the user to the user's social media account with a watermark comprising a defined symbol, e.g., a hashtag symbol in front of the name of the resource provider who issued the digital resources. Additionally, or alternatively, the computing system may automatically mark the content being shared by the user to the user's social media account with a watermark consisting of a representation of the name of the resource provider who issued the digital resources.

The web (or news) feed for the platform may present user-generated content (e.g., photos, videos, etc.) from a plurality of users, which are uploaded by users in exchange for digital resources and increases in quantity thereof. The web feed content that is accessible to users (e.g., merchants and customers) of the platform may vary and depend on privacy settings of the content items and user privileges of the users. A content item, such as a photo or video, uploaded by a user that collects digital resources from a resource provider may be accessed/viewed by: a plurality of resource providers on the platform; users with accounts on the platform; users without accounts on the platform; users who have previously interacted with the resource provider; and/or users who have not interacted with the resource provider.

The web feed content may be determined by a recommender engine associated with the resource server. The recommender engine is configured to predict, at least: the content that a user of the platform may be interested in viewing; which other resource providers on the platform a user may be interested in exploring; and what content a user will engage with. The recommender engine may make the predictions using analytics from users' digital resources earning history; user engagement with displayed content; and profile data of users.

A system and methods for creating a customized digital resource allocation program are disclosed. A recommender engine is configured to provide, in real-time, customized offers to users of a digital resource platform. Users of the platform can redeem the customized offers, using rewards collected, if they have collected sufficient quantity of rewards from the specific resource provider for an offer, as published on the platform.

The recommender engine requests a series of inputs from a resource provider on the platform when setting up a rewards program on behalf of the resource provider account. The inputs will lead to further input requests until the recommender engine obtains sufficient data to recommend the best digital resource allocation program method for the resource provider account. The platform may request a confirmation from the resource provider before publishing the resource provider's customized digital resource allocation program. The resource provider may have option to further customize or publish the customized digital resource allocation program as recommended by the recommender engine.

The recommender engine requests input of data that may include a merchant's industry category, the average or regular or approximate amount of customers the merchant's business receives in a given set of time, the average or regular or approximately value of a customers spend during visits or shopping experience for a given set of time or single visit, and, depending on the previous selections the recommender engine may request the resource provider's preference on how the merchant would like their customers to earn rewards at the business.

The recommender engine displays the recommended digital resource allocation program for the merchant. The merchant can publish the recommendation or select different options for an alternative outcome. The published method may entail the instructions of how the customer can increase their rewards by uploading user-generated content (e.g., images, videos) of their interactions with the merchant. The published method may entail the instructions of how the customer can increase their rewards by sharing their user-generated content (image or video) of their experience with the merchant on to social media. The published method may entail the value of rewards increase for when the customer uploads a user-generated content. The published method may entail the value of rewards increase for when the customer shares the user-generated content to social media.

Once published, the customized digital resource allocation program can be edited and re-published on the resource provider's profile by the resource provider from the resource provider's account, in real time.

The recommendations for a customized digital resource allocation program may be based on categorizing business industries into distinct categories, such as: Category 1 (food & drink, flights, resorts, beauty & wellness, health & fitness, adventure & activities, entertainment & classes, florists, home services & general contractors, automotive, retail, web services, etc.); Category 2 (professional services, such as law, mortgage, accounting etc.); and Category 3 (real estate).

The customized digital resource allocation program may be recommended by the platform based on the business industry and customer type for the specific industry as identified by the merchant. Examples of recommendations may be as follows:
Digital resource allocation program recommendation for Category 1: If they have a high volume of repeat customers, every dollar spent gets X reward.
Digital resource allocation program recommendation for Category 1: If they have a low volume of repeat customers, a specific item purchased gets X reward OR a specific service purchased gets X reward OR any purchase gets X reward.
Digital resource allocation program recommendation for Category 2: If they have a high volume of repeat customers, every dollar spent gets X reward.
Digital resource allocation program recommendation for Category 2: If they have a low volume of repeat customers, any service rendered gets X reward OR a specific service rendered gets X reward.
Digital resource allocation program recommendation for category 3: Any property sold gets X reward.
Digital resource allocation program recommendation for category 3: Any property bought gets X reward.
Digital resource allocation program recommendation for category 3: Any property bought or sold gets X reward.

The present application discloses a system and methods for creating, editing and publishing customized offers, in real time, from merchant accounts on a digital resource platform. A merchant's offers may correlate with the merchant's digital resource allocation (e.g., customer loyalty) program. The offers are redeemable, in real time, in the merchant's customized digital resource allocation program. The offers are created through a recommender engine, which displays options of items for the merchant to select, based on the merchant's digital resource allocation program type. The offers are published onto the merchant's profile on the platform which may be viewed by a plurality of other merchants and a plurality of users of the platform. Based on the merchant's selection from the recommender engine to publish their customized digital resource allocation program, the recommender engine may provide recommendations of relevant offer types for the merchant to create customized offers.

In some implementations, the offer data of offers may include an image that may or may not be uploaded by the merchant, the offer details, and a redeem action button for users to redeem the offer.

The platform may be configured to perform an “Automated Rewards Multiplier” for merchant's offers, to offer merchant's customers a rewards increase based on the spend amount or number of purchases, needed for an offer from the merchant, per the merchant's input of requirements. The rewards increase proceeds by incrementally increasing an initial rewards amount for when the customer uploads a photo of their interactions with the merchant and when the customer shares a photo of their experience with the merchant onto social media.

The present application discloses a system and methods for managing display of search results for queries on a digital resource platform. The system enables presenting search results associated with merchants of a specific type with higher priority relative to search results of other merchants. In particular, search results that are associated with merchants having or implementing a digital resource allocation program may be prioritized in the display of search results. Merchants of all account and profile types on the platform that relate to a search query may be presented in the form of a tiered search result list. From this set of accounts and profiles, the system may only display the merchants on the digital resource platform having a digital resource allocation program account, on the first (or highest priority) tier at the top of the list, to the user performing the search, above any other merchant accounts and/or profiles which may include merchant accounts or profile types that do not have digital resource allocation program accounts on the digital resource platform.

When a user of the digital resource platform submits a search query, merchant information returned in the search results may represent merchants of interest to the user. The digital resource platform searches a database storing merchant information associated with merchant accounts/profiles that have stored data which are relevant to the user's search query. The database will determine which merchant account and/or profiles within this set hold a digital resource allocation program account, which merchant accounts or profiles hold an account on the platform without a digital resource allocation program, and which merchant profiles have an unverified profile page for the category and any related sub-category that is relevant to the search query of the user.

The digital resource platform pulls all merchant information from the database that hold an account and/or profile with relevant categories and subcategories in relation to the user's search query. The platform determines which merchant accounts within this data set hold digital resource allocation program accounts within the database and which merchant accounts and/or profiles do not hold digital resource allocation program accounts within the database. The digital resource platform will then display the merchant information to the user in the form of tiered lists, prioritizing the search results associated with merchants holding a digital resource allocation program account by presenting them at the top of the list (or otherwise visually prioritized), above all other types of merchant accounts and profiles.

In some implementations, the system may only display the merchant information of merchants holding a digital resource allocation program account in the database in the first tier, at the top of the list, above any other list which may include merchant information of merchants that do not have a digital resource allocation program account on the digital resource platform or merchant profiles that don't hold an active account on the digital resource platform.

The list may include objects that are associated with each merchant, such as, but not limited to: merchant information, merchant's business name, merchant's business logo, merchant's business display pictures, merchant's phone number, merchant's star rating determined by user's of the platform and updated in real time, merchant's area of operation such as city, province, country, and merchant's digital resource allocation program account status determined by a star icon and the words “Earn Rewards” for the merchant accounts that offer a digital resource allocation program.

When any object in the presented merchant/s list is clicked, the user may be redirected to the profile page of the merchant in which that object is associated with, on the digital resource platform.

The present application discloses a method and system for publishing relevant user-generated content on a web feed through a recommender engine. The user-generated content represents content items that have been uploaded by a plurality of users in exchange for an increase in digital resources sent by a plurality of merchants.

A method and system for displaying relevant curated user-generated content on a web feed are disclosed. The system may use a recommender engine to display curated content that was uploaded on the platform by users earning rewards, as user-generated content in exchange for digital resources, to other users viewing the web feed. The recommend engine may use the viewers' Rewards Earned history to determine which content uploaded to display, that promote merchants that may be of interest to the viewer, and/or the viewers' content engagement history to determine which content uploaded to display, that promote merchants that may be of interest to the viewer.

Additionally, or alternatively, the system may use a recommender engine to display curated content that was uploaded on the platform by users earning rewards, as user-generated content in exchange for digital resources in exchange for rewards to other users viewing the web feed. The recommender engine may be based on collaborative analytics and/or profile data that was inputted by viewing user.

An example implementation of a platform for digital resource allocation will now be described.

Businesses issue their customers a quantity of initial reward/s, based on customer's purchase and/or purchase value, in accordance with the businesses' customized pre-set-up loyalty rewards program created on the platform. Businesses can send the initial rewards amount from their logged in platform account by entering the customers phone number and the initial rewards amount, and clicking a send button-rewards value will be based on the customer's purchase and/or purchase value, in accordance with the business's pre-set-up loyalty rewards program.

Businesses can have the platform's loyalty rewards technology API integrated on their e-commerce shop that automatically sends the appropriate initial reward/s amount to the customer, based on the customer's purchase and/or purchase value, in accordance with the business's pre-set-up loyalty rewards program. Further, businesses can have the platform's loyalty rewards technology API integrated to their POS system that automatically sends the appropriate initial reward/s amount to the customer, based on customer's purchase and/or purchase value, in accordance with business's pre-set-up loyalty rewards program.

The system may determine if the rewards are being sent to: a current user of the platform and a current rewards collector of the business sending the rewards; a current user of the platform that has not collected any rewards from the business sending the rewards; or a new user to the platform that hasn't collected any rewards from the business sending the rewards.

When rewards are sent by the business to:
1. A current user of the platform and a current rewards collector of the business sending the rewards, then, the new rewards amount data value would be added to the existing amount of rewards data value, from the business, if there was an existing amount. If there was no existing amount of rewards value for that user, from that business, then the new recent rewards value amount will be applied for that user, to collect from that business. The new rewards data value will be updated on the database and on all relevant pages.
2. A current user of the platform and new rewards collector of the business sending the rewards, then, the new recent rewards amount value will be applied for that user, to collect from that business. The new rewards data value will be updated on the database and all relevant pages.
3. A new user to the platform, the rewards value sent and the associated user data that was used to send the rewards is updated on the database but not on any of the relevant pages, at this point.

Customers may receive a notification via an app or message, notifying them that they have earned rewards and they must login to the platform to claim the rewards. The notification may indicate: the quantity of rewards earned; the name of the business that sent the rewards; a message prompting them to take action; if this is seen on text message, then a link to a page on the platform's site where they can perform the action.

Once customer clicks on the link to claim their rewards or takes the claim the rewards action from the app:
1. If the customer is a new user to the platform, the customer is asked to sign up to the platform to become a platform user. Once they sign up, all relevant data for the new rewards value is updated in the system and applied to all relevant pages in both the new user's account and the account of the business that sent the rewards. The customer is then taken to the Increase Your Rewards for Uploading a Photo or a Video of Your Experience Page.
2. If the customer is a return user to the platform, that may or may not have earned rewards from this business prior to receiving this text, then they are asked to login if they are not already logged in. Once they've logged in, the customer is taken to the increase Your Rewards for Uploading a Photo or a Video of Your Experience Page.
3. If the customer is a return user to the platform that may or may not have earned rewards from this business prior to receiving this text, and they are already logged into the platform, the customer is taken directly to the Increase Your Rewards for Uploading a Photo or a Video of Your Experience Page.

Customers are then immediately presented with a Call-to-Action prompt, to upload a photo or a video of their experience with the business they've earned rewards with, to increase the initial rewards amount that they have already earned. The user can select a photo or video to upload onto the platform for additional rewards. Alternatively, the user can click on the, “No thank you, maybe later” action button—and refuse to upload a photo or video at this time. If the user selects this option, they won't receive the additional rewards. They can still exercise this incentive and earn the additional rewards, through their account, at a later time, for as long as they don't receive a new set of additional rewards from the same business for a new purchase. If they receive a new set of rewards from the business for a new purchase, the old incentives for this action will expire for the old rewards value amount and will be replaced by an incentive for the new rewards value amount, which is based on the new set of rewards earned for the new purchase.

Once the customer selects a photo or a video to upload and clicks the upload button, the image is filtered through a third-party API that filters inappropriate content using machine learning models-adult content, violent content and spoof content will be filtered and blocked from upload. If the filter blocks inappropriate content, a message will appear notifying the user that they must select another photo or video to upload. Users can proceed to select another photo or exit the application and try again later.

If the customer's upload passes the image filter, then the additional rewards value for uploading this image may be applied to the database and be visible on all relevant pages, such as: business/merchant/supplier's “Customer Rewards” page; public user's “My Rewards” page; “Redeem Rewards” page.

The upload may be immediately published on customer's profile page. The upload may be immediately published on the profile page of the business that sent the rewards. The upload will be in que to appear on the web feed in accordance to the user's profile set up (private account vs public account), and our machine learning web feed algorithm. The next set of rewards-increase-incentives for sharing this upload onto social media is unlocked and can be exercised in the page that appears instantly or from the user's logged in account at a later time. The user may be immediately taken to the “Share Your Experience on Social Media to Increase Your Rewards Amount” page.

The user may then be immediately presented with another call-to-action prompt-to share the upload onto social media, to earn additional rewards. The image that was uploaded initially, may be altered to include the platform's brands logo and the name of the merchant sending the rewards. The name of the merchant sending the rewards may appear as the actual business name or as a hashtag—with will include the hashtag symbol, followed by the business name. If the business name in the hashtag version has more than one word, there will be no spaces between the words.

The user can select an option from a list of social media share buttons from different social media platforms that they'd like to share on, to earn additional rewards. Depending on the platform, the user can either share a photo or video directly onto the platform, or, the user can share a link to our platform that contains the photo or video that the user uploaded.

Alternatively, the user can click on the, “No thank you, maybe later” action button—and refuse to share the upload onto social media at this time. If the user selects this option, they won't receive the additional rewards. They can still exercise this incentive and earn the additional rewards, through their account, at a later time, for as long as they don't receive a new set of additional rewards from the same business for a new purchase. If they receive a new set of rewards from the business for a new purchase, the old incentives for this action will expire for the old rewards value amount and will be replaced by an incentive for the new rewards value amount, which is based on the new set of rewards earned for the new purchase.

Once the user selects a social media share button of their choice, from a social media platform of their choice, to share their upload, to earn additional rewards, the user will be redirected to the social media site or app. If the user is already logged into the social media site or app, the user will be prompted to hit the post button on the social media site or app, to share the photo/video or link of the photo/video. If the user is not logged into the social media site or app, the user will be prompted to login and once they login, the user will be prompted to hit the post button on the social media site or app to share the photo/video or a link of the photo/video.

Once the user hits the post button, and shares their upload or a link that contains their upload, the system will apply the additional rewards incentive to the database for taking this action.

The new rewards data value may be updated on relevant pages, such as: business/merchant supplier's “Customer Rewards” page; public user's “My Rewards” page; “Redeem Rewards” page.

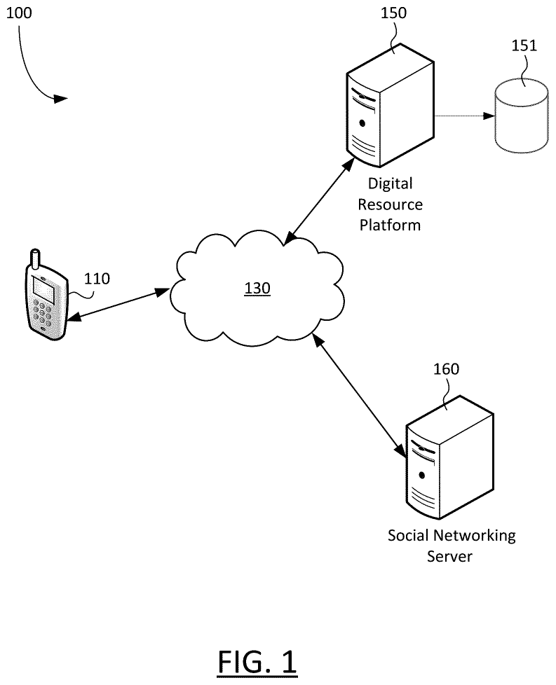

Reference is made to FIG. 1, which is a schematic diagram illustrating an exemplary computing environment 100 consistent with certain disclosed implementations. As shown in FIG. 1, the computing environment 100 may include one or more client devices 110, a digital resource platform 150, a database 151 associated with the digital resource platform 150, a social networking server 160, and a communications network 130 connecting one or more of the components of computing environment 100.

The digital resource platform 150 (which may also be referred to as a server computer system) and the client devices 110 communicate via the network 130. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type.

The client device 110 is associated with a client entity (e.g., an individual, an organization, etc.) having resources that are managed by or via the digital resource platform 150. For example, the digital resource platform 150 may be a server implementing a service platform (e.g., digital resource platform) and the client entity may be a user (e.g., a merchant, a customer, etc.) of the platform. The client device 110 may store software instructions that enable the client device to establish communications with the digital resource platform 150 and the social networking server 160.

The digital resource platform 150 may track, manage, and maintain resources, make lending decisions, and/or allocate resources to one or more resource accounts. The resource accounts are associated with a plurality of client entities. In at least some implementations, the resources may comprise digital resources such as, for example, reward points, digital vouchers, virtual currency, or other stored value objects (e.g., tokens). The resources may be represented in a database 151. The digital resource platform 150 is coupled to the database 151, which may be provided in secure storage. The secure storage may be provided internally within the digital resource platform 150 or externally. The secure storage may, for example, be provided remotely from the digital resource platform 150. For example, the secure storage may include one or more data centers. The data centers may, for example, store data with bank-grade security.

The database 151 may include data records for a plurality of resource accounts and at least some of the records may define a quantity of resources associated with the accounts. For example, a client entity may be associated with an account having one or more records in the database 151. The records may reflect a quantity of stored resources that are associated with the client entity. Such resources may include owned or accumulated resources. The quantity of resources that are available to or associated with the client entity may be reflected by a balance defined in an associated data record such as, for example, a digital resource (e.g., loyalty points) balance.

In at least some implementations, the database 151 may store various types of information for users associated with accounts at the digital resource platform 150. For example, the database 151 may store customer profile data, customer financial account data, merchant profile data, and the like. The customer profile data may include, without limitation, personal information of registered customers, authentication credentials of customers, value card linked with an account (e.g., credit card, debit card, etc.), and information identifying services and programs that the customer has signed up to on the platform. The merchant profile data may include, without limitation, personal information of registered merchants, authentication credentials of merchants, merchant storefront data, digital resources policies, etc.

The digital resource platform 150 may be configured to provide a user interface that allows users to access features of a service platform. By way of example, the digital resource platform 150 may be configured to provide a website or web-based portal which can be accessed via the client devices 110. The website (or portal) may include web content corresponding to various features that are available on the platform, and the digital resource platform 150 may provide the web content for display on the client devices 110. As another example, the digital resource platform 150 may be associated with a software application which may be installed and/or run on the client devices 110. More particularly, the digital resource platform 150 may implement the backend of an application (e.g., mobile application) that is used for accessing the features of a service platform.

In some implementations, the digital resource platform 150 may be associated with a loyalty program. The digital resource platform 150 may provide a digital platform that supports allocation of digital resources to registered customers. Merchants can register with the platform and administer one or more of their loyalty programs through the platform. Customers of a merchant on the platform can receive digital resources (or other digital resources) in their loyalty program accounts which are managed by the digital resource platform 150. In particular, digital resources of a merchant may be allocated to customer accounts on the platform in response to certain actions (e.g., purchase transactions) that are performed by the customers in connection with the merchant.

The digital resource platform 150 may be configured to perform various functions of traditional loyalty programs. In at least some implementations, the digital resource platform 150 may track, manage, and maintain loyalty points information for a plurality of user accounts on the digital resource platform. For example, the digital resource platform 150 may store or have access to a database containing data records associated with loyalty program accounts of users. The digital resource platform 150 may update account data of customer accounts based on information relating to user actions for triggering dynamic allocation of digital resources. For example, a customer's loyalty program account may be updated responsive to a purchase transaction performed by the customer at a storefront of a merchant that administers its loyalty program via the platform.

The digital resource platform 150 may be communicably connected with computing systems associated with third-party affiliates that support the loyalty programs that are linked to the digital resource platform 150. The digital resource platform 150 may obtain product data of rewards (e.g., merchandise, services, etc.) that are offered by the affiliates. In particular, the digital resource platform 150 may obtain product data of one or more products for which customers can redeem their loyalty points. The product data may be obtained by, for example, querying databases associated with the affiliates and/or by using defined API calls for the affiliate systems. The product data may be stored by the digital resource platform 150, in some implementations. The digital resource platform 150 may obtain product data from the affiliates periodically or upon request, and updated product data of rewards may be maintained.

The computing environment 100 includes at least one social networking server 160. A social networking server 160 is a computer system that is associated with one or more providers of social media and social networking services (e.g., Facebook™, Twitter™, Pinterest™, LinkedIn™, etc.). The social networking server 160 may be configured to maintain social networks having members (e.g., individuals, businesses, etc.) that are linked together through one or more member-established relationships. A provider of a social network associated with the social networking server 160 may establish an application programming interface (API) through which the social networking server 160 may receive data from devices associated with members of the social network and through which social media data may be broadcast to the member devices. The social media data includes data relating to social media activity of the members. For example, the social media data may include reactions data (e.g., likes) associated with content on the social network, messages (e.g., direct messages), posts, status updates, shares, tweets, comments, and the like. The social media data may be transmitted to member devices at regular intervals or in response to polling requests from member devices. In particular, social media data may be obtained from a social networking server 160 via a social media API that allows for reading from and writing data into the social network.

The client device 110, the digital resource platform 150, and the social networking server 160 may be in geographically disparate locations. Put differently, the client device 110 may be remote from at least one of the digital resource platform 150 and the social networking server 160. As described above, each of the client device 110, the digital resource platform 150, and the social networking server 160 may be a computer system.

The network 130 is a computer network. In some implementations, the network 130 may be an internetwork such as may be formed of one or more interconnected computer networks. For example, the network 130 may be or may include an Ethernet network, an asynchronous transfer mode (ATM) network, a wireless network, or the like. Additionally, or alternatively, the network 130 may be or may include one or more payment networks. The network 130 may, in some implementations, include a plurality of distinct networks. For example, communications between certain of the computer systems may be over a private network whereas communications between other of the computer systems may be over a public network, such as the Internet.

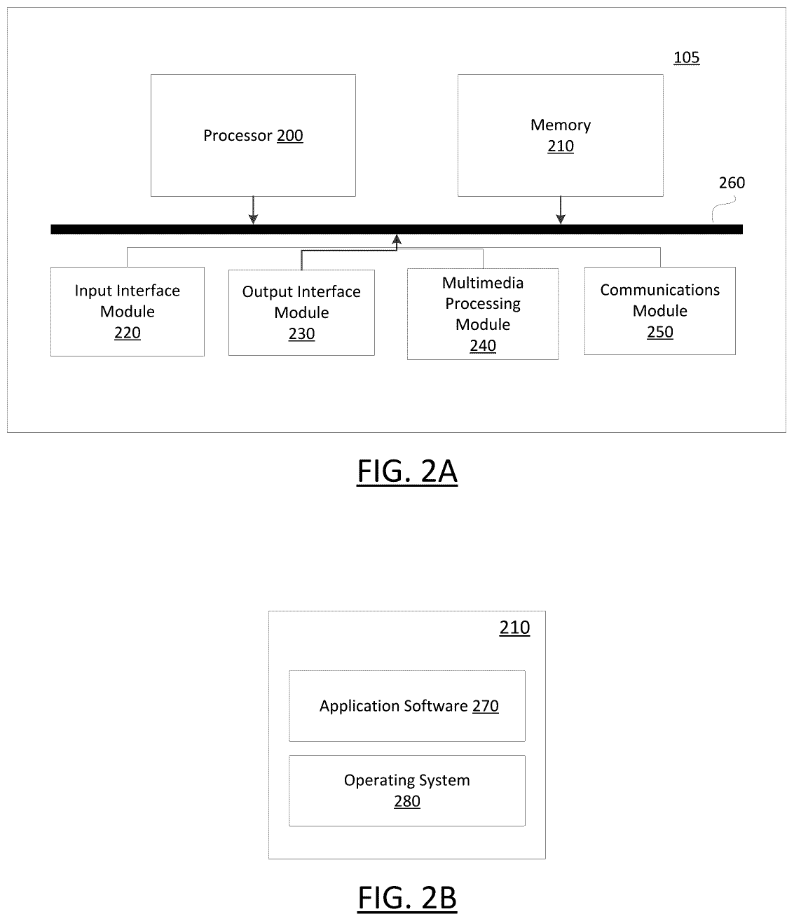

FIG. 2A is a high-level operation diagram of an example computing device 105. In at least some implementations, the example computing device 105 may be exemplary of one or more of the client device 110, the digital resource platform 150, and the social networking server 160. The example computing device 105 includes a variety of modules. For example, as illustrated, the example computing device 105, may include a processor 200, a memory 210, an input interface module 220, an output interface module 230, multimedia processing module 240 and a communications module 250. As illustrated, the foregoing example modules of the example computing device 105 are in communication over a bus 260.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 250 allows the example computing device 105 to communicate with other electronic devices and/or various communications networks. For example, the communications module 250 may allow the example computing device 105 to send or receive communications signals. Communications signals may be sent or received according to one or more protocols or according to one or more standards. For example, the communications module 250 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 250 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 250. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. For example, the application software 270 may cooperate with the operating system 280 to adapt a suitable embodiment of the example computing device 105 to operate as the client device 110, the digital resource platform 150, or the social networking server 160. The application software 270 may, for example, include a resource account management application. In some example implementations, a resource account management application may allow users to access and control various aspects of their accounts, for example, at a resource server. For example, the resource account management application may comprise a mobile banking application for managing personal or business bank accounts. A resource account management application may provide a functionality of managing features of value transfer cards that are associated with resource accounts (and data records of those resource accounts). In particular, customers of a financial institution may use a resource account management application on their devices to access card data of their value transfer cards, such as current balance, transactions history, accumulated digital resources credits, etc.

While a single application software 270 is illustrated in FIG. 2B, in operation, the memory 210 may include more than one application software 270 and different application software 270 may perform different operations.

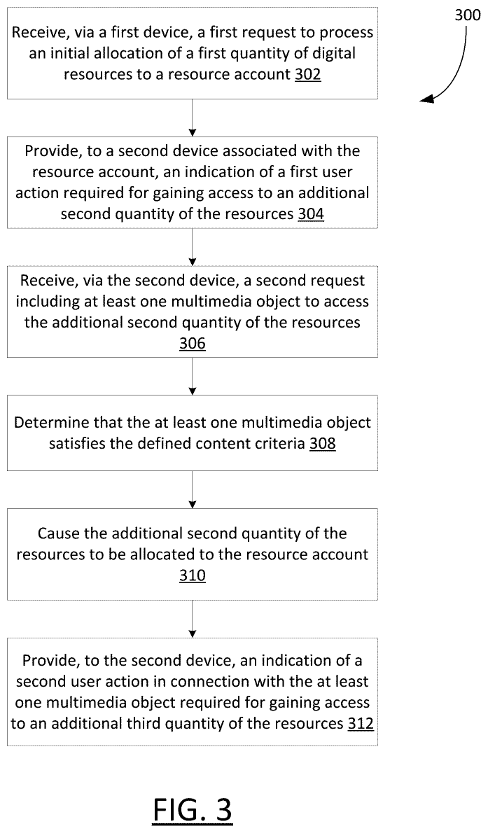

Reference is now made to FIG. 3 which shows, in flowchart form, an example method 300 for controlling allocation of digital resources to a resource account. The method 300 may be implemented by a computing system that is configured to access and manage a plurality of resource accounts, such as the digital resource platform 150 of FIG. 1. Operations 302 and onward may be performed by one or more processors of a computing device such as, for example, the processor 200 (FIG. 2A) of suitably configured instances of the example computing device 105 (FIG. 2A).

In operation 302, the digital resource platform receives a first request to process an initial allocation of a first quantity of resources to a resource account. The resources may comprise various different types of resources, such as digital resources. The first request is received via a first computing device. More particularly, the first request may originate from a resource sender that desires to allocate (i.e., transfer, distribute, allot, etc.) a defined quantity of resources to a recipient. The resources may be allocated, for example, in response to a particular action that is performed by the recipient.

By way of example, a merchant that administers a loyalty program may transmit, to the digital resource platform using their device, a first request to process an initial allocation of a first quantity of loyalty points to a customer of the merchant. The initial allocation of loyalty points may be a response to a purchase transaction (or other action) performed by the customer in connection with a storefront of the merchant. The first request may be input in a software application that is resident on the merchant device. For example, the first request may be received via a software application associated with a digital resource platform. A graphical user interface for the software application may provide input fields for entering one or more request parameters of the first request. Upon confirmation by the resource sender, the request parameters may be transmitted to the digital resource platform.

The first request may include, at least, identifying information for a designated recipient for the initial allocation of resources. For example, the first request may include an identifier (e.g., name) and contact information, such as an email address, a telephone number, etc., of a recipient. In some implementations, the first request may additionally include an indication of a resource account associated with the recipient. For example, in the context of a digital resource platform, the first request may include a loyalty program account number associated with the recipient.

The first request also includes an indication of the first quantity of resources that is to be allocated to the resource account. That is, the first request specifies a numerical value representing a quantity of resources for allocation. Additionally, or alternatively, the first request may include an indication of a type of resource(s) to allocate to the resource account. For example, the resource sender may own multiple different types of resources, and the first request may indicate the resource sender's desired resource type for the initial allocation.

After the initial allocation of the first quantity of resources has been processed, the resource sender may provide an opportunity to the recipient to increase the resources that are to be allocated to the recipient's account. By way of example, the resource sender may desire to incentivize the recipient to perform certain actions such that a defined second quantity of resources, additional to the first quantity, may be allocated to the recipient's account conditioned on the completion of such actions. More generally, the digital resource platform supports allocating additional resources to a recipient's account based on the recipient satisfying dynamically defined criteria for receiving such additional resources.

In operation 304, the digital resource platform provides, to a second device associated with the resource account, an indication of a first user action required for gaining access to an additional second quantity of the resources. The first user action comprises an upload, via the second device, of multimedia data to the digital resource platform. In at least some implementations, the indication may take the form of a message, such as a text message, an email, a push notification, and the like, that is provided to the recipient's device. For example, an in-app message or notification of a software application associated with a digital resource platform may include an indication of the first user action. The message/notification may, for example, comprise a prompt for the recipient to initiate a certain action for increasing the quantity of resources that is allocated to the recipient's account. The prompt may include a multimedia input request for prompting user input of a selection of a multimedia object to upload. For example, a graphical user interface for the software application may include a user interface element, such as an image selection button, an image input field, etc., that enables the recipient to select and initiate upload of a multimedia object.

The indication of the first user action may be provided in response to completion of the initial allocation of the first quantity of resources. In particular, the recipient may be notified of the first user action only after the first quantity of resources has been allocated to the recipient's account.

Additionally, or alternatively, the indication of the first user action may specify various requirements of the first user action. In at least some implementations, the requirements may comprise upload criteria relating to the multimedia object upload. The upload criteria may relate to multimedia object type. For example, the indication may specify one or more types (e.g., photos, videos, etc.) of multimedia objects that would be acceptable as part of the user's upload action.

In operation 306, the digital resource platform receives, via the second device, at least one multimedia object. The at least one multimedia object may be uploaded as part of a request to access the additional second quantity of the resources. In particular, the recipient of the initial allocation of resources may perform the first user action (i.e., multimedia object upload) in order to increase the resources that are allocated to the recipient's account.

The digital resource platform then determines whether the at least one multimedia object satisfies defined content criteria, in operation 308. That is, the digital resource platform is configured to process the multimedia data of the uploaded multimedia object and determine if the uploaded content satisfies requirements for additional allocation of resources to the recipient's account. The content criteria may comprise various requirements in relation to the content of the uploaded multimedia object. In analyzing the multimedia data, the digital resource platform may implement various computer vision and image processing techniques. For example, the digital resource platform may perform feature detection, objection detection, template matching, contextual image classification, etc. using the uploaded multimedia object.

In at least some implementations, the content criteria may specify that the uploaded multimedia object is required to be related to a merchant associated with the resource sender. For example, an uploaded multimedia object may be determined to satisfy the content criteria if it depicts a product (i.e., goods or services) that is (1) offered by a merchant associated with the resource sender (e.g., a product that is included in the merchant's catalogue), and (2) verified to be purchased by a customer who uploads the image. As another example, an uploaded multimedia object may be determined to satisfy the content criteria if it depicts a storefront, or parts thereof, of a merchant associated with the resource sender. The digital resource platform processes the uploaded multimedia object and determines whether all the content requirements for allocation of additional requires are satisfied.

In response to determining that the at least one multimedia object satisfies the defined content criteria, the digital resource platform causes the additional second quantity of the resources to be allocated to the resource account, in operation 310. In particular, a further allocation of the second quantity of resources may be authorized responsive to a determination that the uploaded multimedia object satisfies the content criteria. The additional resources may be allocated to the resource account only upon confirming that the content criteria are satisfied by the uploaded multimedia object. That is, the multimedia upload action by the recipient may by itself be insufficient for the additional resource allocation; rather, further allocation may only occur if the uploaded multimedia object satisfies the content criteria.

In operation 312, the digital resource platform provides, to the second device, an indication of a second user action in connection with the at least one multimedia object required for gaining access to an additional third quantity of the resources.

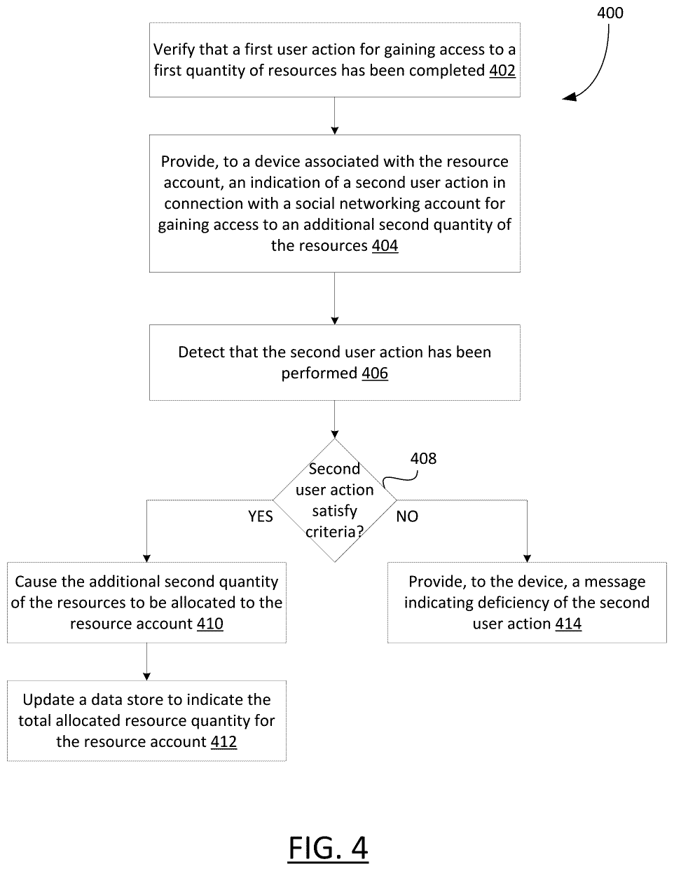

Reference is now made to FIG. 4 which shows, in flowchart form, another example method 400 for controlling allocation of digital resources to a resource account. The method 400 may be implemented by a computing system that is configured to access and manage a plurality of resource accounts, such as the digital resource platform 150 of FIG. 1. Operations 402 and onward may be performed by one or more processors of a computing device such as, for example, the processor 200 (FIG. 2A) of suitably configured instances of the example computing device 105 (FIG. 2A). The operations of method 400 may be performed in addition to, or as alternatives of, one or more of the operations of method 300.

After allocating an initial quantity of resources to a recipient account, a resource sender may desire to incentivize certain user actions by the recipient, by authorizing further allocation of resources that is conditional upon performance of said actions. In some implementations, a sequence of user actions performed by the recipient may effectively unlock access to progressively increasing quantities of resources. That is, as the recipient performs the actions of a defined sequence of user actions, additional resources may be allocated to the recipient's account with each completed action.

In at least some implementations, the user actions may comprise actions which may be performed with respect to a recipient's social networking account. In operation 402, the digital resource platform verifies that a first user action for gaining access to a first quantity of resources has been completed. The first user action may, for example, be an action that is performed by a recipient responsive to a prompt indicating criteria for increasing an initial allocation of resources to the recipient's account. As described with reference to the method 300, the first user action may comprise an upload of a first multimedia object to the resource account management system. By uploading a multimedia object that satisfies certain criteria, the recipient may be eligible to receive an allocation of resources that is additional to a previous allocation to the recipient's account. The digital resource platform may verify that the upload is complete by processing the multimedia data of the first multimedia object and determining that the multimedia data satisfies defined content criteria.

The digital resource platform provides, to a device associated with the resource account, an indication of a second user action in connection with a social networking account for gaining access to an additional second quantity of resources, in operation 404. The second user action may comprise an upload of (or user input of a request to upload), via the device, at least one multimedia object (or a link thereto) to a social networking server in connection with a social networking account. The at least one multimedia object may, for example, be the same object as the first multimedia object, i.e., the object that is uploaded to the digital resource platform for unlocking an initial increase in resources allocated to the recipient account. Alternatively, the at least one multimedia object may be different from the first multimedia object. For example, a multimedia object may be automatically generated by the digital resource platform and the second user action may be the upload of (or user input of a request to upload) the generated multimedia object (or a link thereto) to the social networking server.

In operation 406, the digital resource platform detects that the second user action has been initiated/performed. In some implementations, the digital resource platform may detect that the user has requested for a multimedia object (or a link thereto) to be uploaded to a social networking account associated with the recipient. In some implementations, the digital resource platform may query the social networking server (for example, via API calls) to determine/confirm whether a multimedia object (or a link thereto) has been uploaded to a social networking account associated with the recipient. The upload may be performed, for example, after the recipient successfully logs in to their account with the social networking server and initiates an upload (e.g., content posting) action from within their social networking account. The recipient's account activity, including the multimedia object upload, in connection with their social networking account may be determined based on querying and/or receiving communication from the social networking server regarding account data of the recipient's social networking account. Additionally, or alternatively, the digital resource platform may receive, via the recipient's device, an indication that the at least one multimedia object has been uploaded to the recipient's social networking account.

If the second user action is determined to satisfy defined criteria (operation 408), the digital resource platform causes the additional second quantity of the resources to be allocated to the resource account, in operation 410. The defined criteria may comprise, for example, content criteria for a multimedia object associated with a multimedia upload action. In particular, the digital resource platform may be configured to analyze the content of an uploaded multimedia object to assess whether it satisfies defined content criteria. Once the additional second quantity of resources is allocated to the resource account, the digital resource platform updates a data store to indicate a total allocated resource quantity for the resource account, in operation 412.

If, on the other hand, the second user action is determined to not satisfy the criteria, the digital resource platform provides, to the recipient's device, a message indicating deficiency of the second user action, in operation 414. For example, the message may specify an error with processing of the second user action by the social networking server. As another example, the message may indicate one or more requirements which are not satisfied by the second user action performed by the recipient. The message may be presented via the recipient's device responsive to completion of the second user action by the recipient.

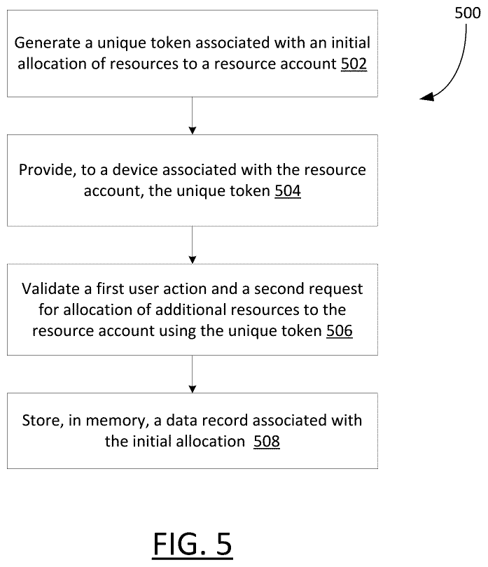

Reference is now made to FIG. 5 which shows, in flowchart form, an example method 500 for validating requests to allocate digital resources to a resource account. The method 500 may be implemented by a computing system that is configured to access and manage a plurality of resource accounts, such as the digital resource platform 150 of FIG. 1. Operations 502 and onward may be performed by one or more processors of a computing device such as, for example, the processor 200 (FIG. 2A) of suitably configured instances of the example computing device 105 (FIG. 2A). The operations of method 500 may be performed in addition to, or as alternatives of, one or more of the operations of methods 300 and 400.

While the flexibility to dynamically adjust the allocation of resources to user accounts conditional upon user actions represents an improvement for account management systems, it is desired to prevent exploitation of the allocation mechanism for effecting unwanted increases in resource allocation to a user account. In an embodiment, requests to allocate resources to a resource account are first required to be validated. In operation 502, the digital resource platform generates a unique token associated with an initial allocation of resources to a resource account. The token data of the unique token represents data for use in verifying that requests to increase resource allocation originate from an authorized entity, i.e., the designated recipient of the initial allocation of resources. In the context of a digital resource platform, the unique token may be used to identify a specific customer that is using the platform to collect digital resources. In some implementations, the token data may be encrypted. The token is linked exclusively to the customer.

In operation 504, the digital resource platform provides, to a device associated with the resource account, the unique token. That is, the token is provided to a recipient of the initial allocation of resources, such that the recipient alone is authorized to request increases to the initially allocated quantity of resources.

In operation 506, the digital resource platform validates a first user action and/or a second request for allocation of additional resources to the resource account using the unique token. In particular, the token is used to verify that the first user action required for increasing the allocated resources to the recipient's account is indeed performed by the recipient. Similarly, the token may be used to verify that the second request to increase the allocated resources originates from the recipient.

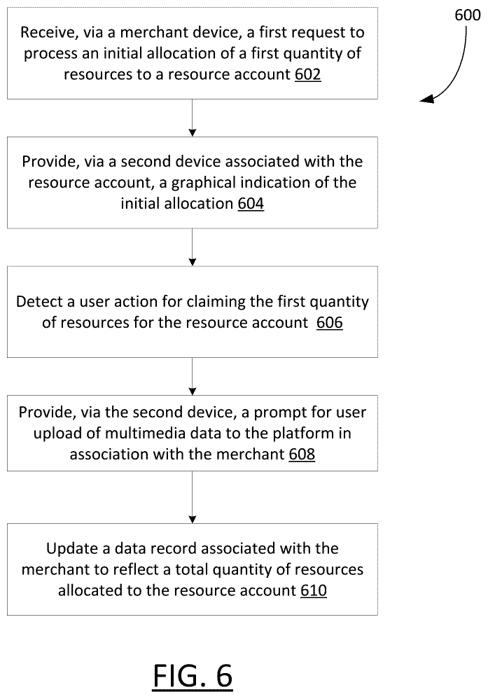

Reference is now made to FIG. 6 which shows, in flowchart form, an example method 600 processing a merchant request to allocate digital resources to a customer. The method 600 may be implemented by a computing system that is configured to access and manage a plurality of resource accounts, such as the digital resource platform 150 of FIG. 1. Operations 602 and onward may be performed by one or more processors of a computing device such as, for example, the processor 200 (FIG. 2A) of suitably configured instances of the example computing device 105 (FIG. 2A). The operations of method 600 may be performed in addition to, or as alternatives of, one or more of the operations of methods 300, 400, and 500.

As described above, digital resources, such as loyalty points, digital vouchers, and other stored value objects, may be allocated to resource accounts. The allocation of resource may be initiated by a merchant administering a loyalty program. In operation 602, the digital resource platform receives, via a merchant device, a first request to process an initial allocation of a first quantity of resources to a resource account. The resource account may, for example, be a user account associated with a customer of the merchant, and the first quantity may represent a quantity of resources that is allocated for a defined customer action (e.g., purchase transaction) in connection with the merchant.

In operation 604, the digital resource platform provides, via a second device associated with the resource account, a graphical indication of the initial allocation. More particularly, the quantity of initially allocated digital resources may be presented via a graphical user interface on a customer device. The digital resource platform detects performance of a user action for claiming the first quantity of resources for the resource account, in operation 606.

In operation 608, the digital resource platform provides, via the second device, a prompt for user upload of multimedia object data to the digital resource platform in association with the merchant. The prompt may include a multimedia input request for prompting user input of a selection of a multimedia object to upload. In operation 610, the digital resource platform updates a data record associated with the merchant to reflect a total quantity of resources allocated to the resource account.

An example implementation of a web feed for a digital resource platform will now be described. When a merchant provides rewards/points to a user (e.g., a customer of the merchant), the user is asked if they would like to increase the initial rewards amount by uploading an image of their experience with the merchant sending the rewards. The user may accept or decline to do it at the moment and opt to do it later. When the user does upload an image to increase the initial rewards amount, the image may appear on three sections of the platform: the merchant's profile page; the user's profile page; and the platform web feed for other users to view, based on the uploader's privacy settings and the recommender engine rules.

The recommender engine may use several different models to recommend customized curated content of user-generated content that was uploaded onto the web feed in exchange for loyalty rewards, for other viewers/users on the web feed. The recommender engine may use the viewers “rewards earned” history to determine which content uploaded to display, that promote merchants that may be of interest to the viewer. The recommender engine may use the viewers content engagement history to determine which content uploaded to display, that promote merchants that may be of interest to the viewer. The recommender engine may be based on collaborative analytics of all users on the platform. The recommender engine may be based on profile data that was inputted by the viewing user.

There may be four different account holder types: public users with account settings set to private; public users with account settings set to public; paid business owner account holders (businesses, merchants, suppliers that have a loyalty rewards program with the platform); and free claimed business owner account holders (businesses, merchants, suppliers that don't have a loyalty rewards program with the platform).

All account holders, both business account holders and public users, can see user-generated content (UGC), in the form of photo/video uploads, in their web feed, which is the home page when they login. Public users (e.g., consumers) that have their profile settings set to “private” can see user-generated content uploaded by the businesses they've visited; can see user-generated content uploaded by other businesses that they might be interested in visiting—as determined by ai algorithms and data; can see user-generated content uploaded by their accepted friends list; can see user-generated content uploaded by other public users that have their account settings set to public but may not be connected as a friend on the friend's list. However, the user-generated content of this account holder (public user with their account settings set to “private”) can only be viewed by other public users connected on the friends list and/or the businesses the public user with their account settings set to private account has earned rewards from.

Public users that have their profile settings set to “public” can see user-generated content uploaded by the businesses they've visited; can see user-generated content uploaded by other businesses that they might be interested in visiting—as determined by ai algorithms and data; can see user-generated content uploaded by their accepted friends list; can see user-generated content uploaded by other public users that have their account settings set to “public” but may not be connected as a friend on the friend's list—as determined by data.

However, the user-generated content of this account holder (public user with their account settings set to “public”) can be viewed by all other users, i.e., other public users connected on the friends list, public users that are not connected on the friend's list, businesses that this account holder has earned rewards from and businesses this account holder has not earned rewards from—as determined by data.

Paid business owner account holders (businesses, merchants, suppliers that have a loyalty rewards program with the platform): can see user-generated content from their customers, regardless if the user-generated content is created for earning rewards at their place of business or another business; other public users that have their account settings set to “public”, but has not earned rewards from this business account holder, as determined by data.

Free claimed business owner accounts (businesses, merchants, suppliers that don't have a loyalty rewards program with the platform): public users that have their account settings set to “public”, but has not earned rewards from this business account holder, as determined by data; other business account holders, as determined by data.

When user-generated content is uploaded:
1. If posted by a public user with account setting set to “private” to earn rewards, this user-generated content can appear on public user's profile page, paid business owner's profile page, and on the news feed of public user's accepted Friends (e.g., other public users)
2. If posted by a public user with account setting set to “private”, not to earn rewards, but to simply upload, then, this user-generated content can appear on public user's profile page, and on the news feed of public user's accepted Friends (e.g., other public users)
3. If posted by a public user with account setting set to “public”, to earn rewards, this user-generated content can appear on public user's profile page, paid business owner's profile page, the news feed of public user's accepted Friends (e.g., other public users), the news feed of public users not on their accepted friends list, and other businesses.
4. If uploaded by a public user with account setting set to “public”, not to earn rewards, but to simply upload, then, this user-generated content can appear on public user's profile page, the web feed of public user's accepted Friends (e.g., other public users), the web feed of public users not on their accepted friends list, and other businesses.

All users can “like” the published user-generated content. The numeral value for the amount of likes each user-generated content receives will be updated wherever the user-generated content appears, such as newsfeed, business account owner's profile page and or public user's profile page.

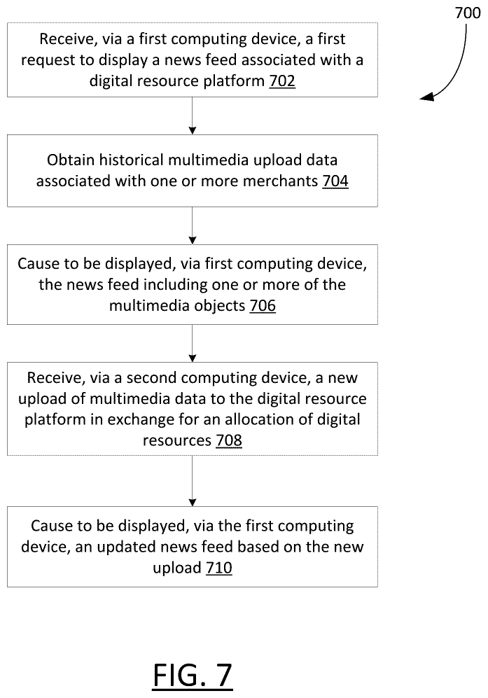

Reference is now made to FIG. 7 which shows, in flowchart form, an example method 700 for providing a news feed associated with a digital resource platform. The method 700 may be implemented by a computing system that is configured to access and manage a plurality of resource accounts, such as the digital resource platform 150 of FIG. 1. Operations 702 and onward may be performed by one or more processors of a computing device such as, for example, the processor 200 (FIG. 2A) of suitably configured instances of the example computing device 105 (FIG. 2A). The operations of method 700 may be performed in addition to, or as alternatives of, one or more of the operations of methods 300 to 600.

The digital resource platform may implement a digital resource platform. In operation 702, the digital resource platform receives, via a first computing device, a first request to display a news feed associated with the digital resource platform. A news feed may comprise a web feed feature through which users of the digital resource platform are exposed to content that is posted on the platform. The news feed may selectively display content representing activities conducted on the platform.

In operation 704, the digital resource platform obtains historical multimedia upload data associated with one or more merchants and/or customers. More particularly, the multimedia objects that were previously uploaded in connection with the requested news feed are retrieved by the digital resource platform. The historical multimedia uploads may then be selectively presented on the requested news feed. By way of example, a customer profile feed may include a selection of multimedia objects (e.g., photos, videos, etc.) that were uploaded to the platform by the customer associated with that specific customer profile feed. As another example, a merchant profile feed may include multimedia objects that were uploaded to the platform by customers of the merchant and/or the merchant themselves.

In operation 706, the digital resource platform causes to be displayed, via the first computing device, the news feed including one or more of the multimedia objects.

In operation 708, the digital resource platform receives, via a second device, a new upload of multimedia data in connection with allocation of digital resources. In operation 710, the digital resource platform causes to be displayed, via the first computing device, an updated news feed based on the new upload. For example, if the new upload comprises a multimedia object uploaded by a first customer of a merchant, both the news feed of the first customer and the news of the merchant may be updated to present the newly uploaded multimedia object.

The present application discloses methods for displaying search results pertaining to merchants of a digital resource platform. Specifically, disclosed herein is a method for displaying tiered search results that prioritizes merchants holding a digital resource allocation program account on the platform.

TABLE 1

| The Three Types of Merchant Business Listings - for | |
|---|---|
| category and subcategory search results on the computer | |
| based platform | Search Result Tier |
| Listings for Merchant's with a loyalty rewards program account | Tier 1 - These listings will rotate in the first tier, in order or |
| on the computer based platform | randomly - above listings from any other tier |
| Listings for Merchants that have a basic account on the | Tier 2 - These listings will rotate in the tier below the first tier, in |
| computer based platform - who do not have a loyalty rewards | order or randomly - this tier will remain above the last tier |
| program account | |
| Listings for Merchants with no account on the computer based | Tier 3 - These listings will rotate in order or randomly, at the |
| platform | very last tier, below all other listings |

The search results for a product or service may be listed in an order that prioritizes different ones of the results. By way of example, the search results may be classified based on whether a result is associated with a merchant that has a digital resource account on the platform; have a basic account on the platform, or have no account on the platform.

A computing system associated with a digital resource platform may be configured to perform such method of displaying search results. The computing system receives, via a computing device, a search query. The computing system then obtains a set of one or more search results based on performing a search of a database using the search query and determines a display order of displaying the one or more search results. The search results may, for example, comprise merchant information associated with the merchant accounts. Each search result may include a link that is associated with a profile page of a corresponding merchant account.

As part of determining the display order, the computing system identifies a first subset of search results that are associated with merchant accounts on a digital resource platform having respective digital resources program enabled and setts the display order such that the first subset of search results is displayed with higher priority than search results that are not included in the first subset.

In at least some implementations, as part of determining the display order, the computing system may identify a second subset of search results that are associated with merchant accounts on the digital resource platform that do not have a respective digital resources program enabled and set the display order such that the second subset of search results is displayed with higher priority than search results that are not included in the first subset or the second subset and lower priority than search results included in the first subset. The search results of the first and/or second subset may be displayed in a random order or in accordance with defined display criteria.

The computing system then causes the one or more search results to be displayed via the computing device in accordance with the display order. For example, the computing system may cause the computing device to display, on a search user interface, search results associated with higher priority before displaying search results associated with lower priority based on the display order.

### Customer Loyalty Rewards Program Recommendations

In order to create a customer loyalty rewards program based on a business' desired outcome in utilizing the loyalty rewards platform, a digital resource platform may prompt an account holder of the business' account for various inputs. These inputs may be used to determine the business category type on the platform which is the basis for the platform to recommend an optimal loyalty rewards program method for the business. These input requests may appear in any order or sequence and may or may not request every input on the list.

The first series of inputs are used to determine the nature of the business. If applicable, the second series of input request may be used to determine what type of customer visits is the norm for the business' industry. Once the platform has received these inputs, it will then recommend an optimal loyalty rewards program method for the businesses' unique business needs. Once the account holder confirms the loyalty rewards program method, they may then create customized offers from an offers template, associated with the selected loyalty rewards program method.

The first series of input requests are to determine the Business Industry. Input requests may or may not contain every input request on this list. Input requests may appear in any order. Input Requests may or may not have every item on this list. The platform will display options of Business Industries and prompt the user to select the business industry that best describes their business. The user may select one option. The Business Industry list may include industries such as Food & Drink, Flights, Resorts, Beauty & Wellness, Health & Fitness, Adventure & Activities, Entertainment & Classes, Florists, Home Services & General Contractors, Automotive, Retail, Real Estate, Law, Mortgages, Accounting, Insurance, Web Services, Professional Services etc.)

Once the user selects the main business industry that best describes their business, the platform will store this data and then fetch all relevant sub industries that are related to the main industry. For example, if the user selected Food & Drink as their main industry, the platform will fetch all related sub industries stored in the database that relate to the Food & Drink industry and then display these relevant sub industries for the user to select. The user may select non or as many sub industries that best describe their business. These sub industries are more specific in describing the nature of the business. Sub Industries for the Food & Drink industry may include Breakfast, Desserts, Steak House, Sandwich Shop, Custom Cakes, Bistro, Catering etc.

Once the user selects the relevant sub industries to their business (if applicable) or decides not to select sub industries but only move forward with the initially main category, then the platform will store the user's selection/s in the database and move onto the next series of input requests for step two in determine the business customer type. The next series of input requests appear for all business categories except Business category Type 3: Real Estate.

The second series of input request/s are to determine the customer type for the merchant's business. The platform will display two options of Customer Type and prompt the user to select the Customer Type that best describes the type of customers that are the norm for the merchant's business. The user may select one option: 1. High Volume of Repeated Customers—For example, a coffee shop can have a high volume of repeat customers since customers can buy coffee everyday or very often. 2. Low Volume of Repeated Customers—For example, a mattress shop will only have a low volume of repeat customers as customers don't need to buy a mattress often.

Once the user selects the customer type that best describes the type of customers that are the norm for their business, the platform will store this data and then fetch and display the recommended customer loyalty rewards program for this merchant's business based on the received inputs from the merchant. Once the user confirms to use the recommended loyalty rewards program for their business by clicking a button, the platform will save this data and publish the merchant's customer loyalty rewards program onto the merchant's profile page on the platform.

There may be three distinct groups of main categories: 1. General category, such as—food & drink, flights, resorts, beauty, wellness, health, fitness, adventure, activities, entertainment, classes, florists, home services, home renovation, general contractors, automotive, retail etc.; 2. Professional services, such as-law, mortgage, accounting etc.; 3. Real estate.

These main categories have been divided into three distinct groups because the method in which their customers can earn rewards from the businesses in these main categories differ, and as such, the platforms must publish the business account holders Ways to Earn accordingly on the business user account's profile page on the platform.

If the user of the business owner account selects a general category and its applicable sub-categories, to set up their ways to earn, the platform will then request the user to select the customer type. The options may include some or all of these options, worded like this or differently, but with the same interpretation:
A. High volume of repeat customers—for example, a coffee shop with many customers that purchase coffee every morning on their way to work would have a high volume of repeat customers.
B. Low volume of repeat customers—for example, a vacation resort may have customers that don't visit regularly, with a majority of customers only visiting once, as vacationers like to travel to different places to acquire different experience.

For the selection of option A, the platform will recommend the user set up their ways to earn with the method, Every dollar spent gets X value reward/s. This method is designed to increase customer spending for businesses that receive high volumes of repeat customers. The merchant will be taken to a confirm your loyalty rewards program page with the recommended loyalty rewards program method. The confirmation page may include the merchant's loyalty rewards program, information on how the business's customers can increase the rewards value earned and how much the rewards value will increase for the actions taken—the actions being, uploading a user-generated content of the customer experience with the business onto the platform and then sharing that experience onto social media.

If merchant accepts the recommendation, the platform will store this input in the database and display this input on the business users merchant profile page.

For the selection of option B, the platform will ask the user to select their preferred method of setting up ways to earn which may include one or more of these three different options: every purchase gets X reward, a specific item purchased gets X reward, a specific service purchased gets X reward. These methods of setting up ways to earn are designed to bring in new customers, and incentivize customers to return again and is designed for bossiness that have a low volume of repeated customers. If user selects “A specific item purchased gets X Reward” or “A specific service purchased gets X reward” the platform will request the user to input what specific item or what specific service purchased receives an X value of rewards.

The platform will store merchant input in the database and display this input on the business users merchant profile page so that users of the platform will know what specific service or what specific item purchased from this merchant is eligible for reward/s.

The merchant will be taken to a confirm your loyalty rewards program page with the recommended loyalty rewards program method. The confirmation page may include the merchant's loyalty rewards program, information on how the business's customers can increase the rewards value earned and how much the rewards value will increase for the actions taken-the actions being, uploading a user-generated content of the customer experience with the business onto the platform and then sharing that experience onto social media.

If the user of the business owner account selects a professional service category and to set up their ways to earn, the platform will then request the user to select the ways to earn method options. The options may include one or both of these options, worded like this or differently, but with the same interpretation:
A. Any service rendered gets X reward
B. A specific service rendered gets X reward

If the user selects option A, then the platform will ask the user to confirm their setting up ways to earn. The user can go back and select a different option or confirm their ways to earn. If the user selects option B, then the platform will request the user to input what specific service rendered receives X value of rewards. The platform will store this input in the database and later display this input on the business users merchant profile page so that users of the platform will know what specific service or what specific item purchased from this merchant is eligible for reward/s.

The merchant will be taken to a confirm your loyalty rewards program page with the recommended loyalty rewards program method. The confirmation page may include the merchant's loyalty rewards program, information on how the business's customers can increase the rewards value earned and how much the rewards value will increase for the actions taken—the actions being, uploading a user-generated content of the customer experience with the business onto the platform and then sharing that experience onto social media.

If merchant accepts the recommendation, the platform will store this input in the database and display this input on the business users merchant profile page.

If the user of the business owner account selects the real estate category to set up their ways to earn, the platform will then request the user to select an option on how they'd like their loyalty rewards program to be set up. The options may include some or all of these options, worded like this or differently, but with the same interpretation: A. Any property bought gets one reward; B. Any property sold gets one reward; C. Any property bought or sold gets one reward.

Once the user selects their option the platform will ask the user to confirm their setting up ways to earn. The user can go back and select a different option or confirm their ways to earn. The confirmation page may include the merchant's loyalty rewards program, information on how the business's customers can increase the rewards value earned and how much the rewards value will increase for the actions taken—the actions being, uploading a user-generated content of the customer experience with the business onto the platform and then sharing that experience onto social media.

If merchant accepts the recommendation, the platform will store this input in the database and display this input on the business users merchant profile page.

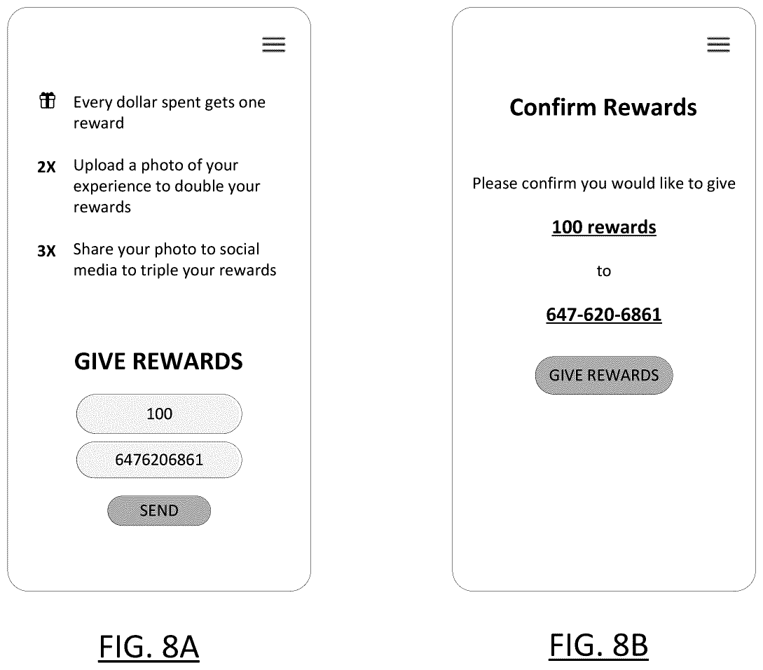

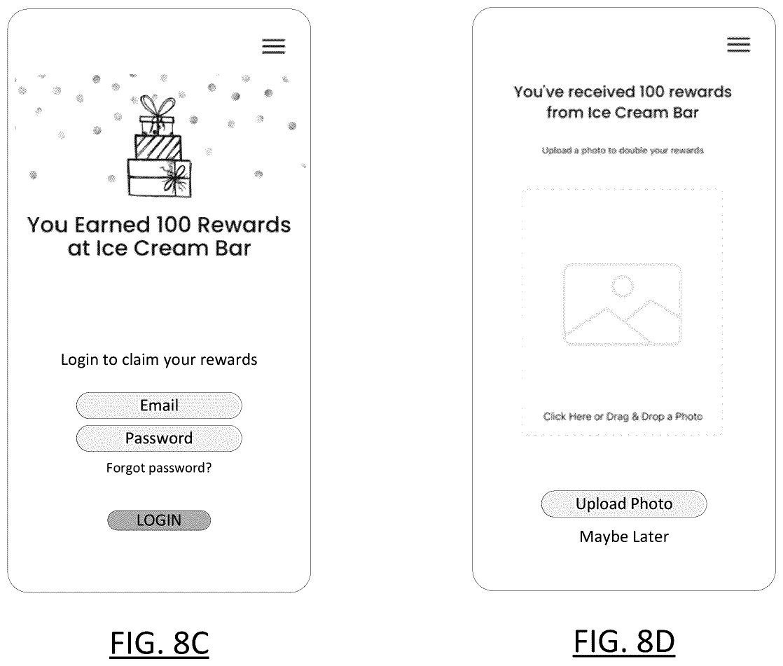

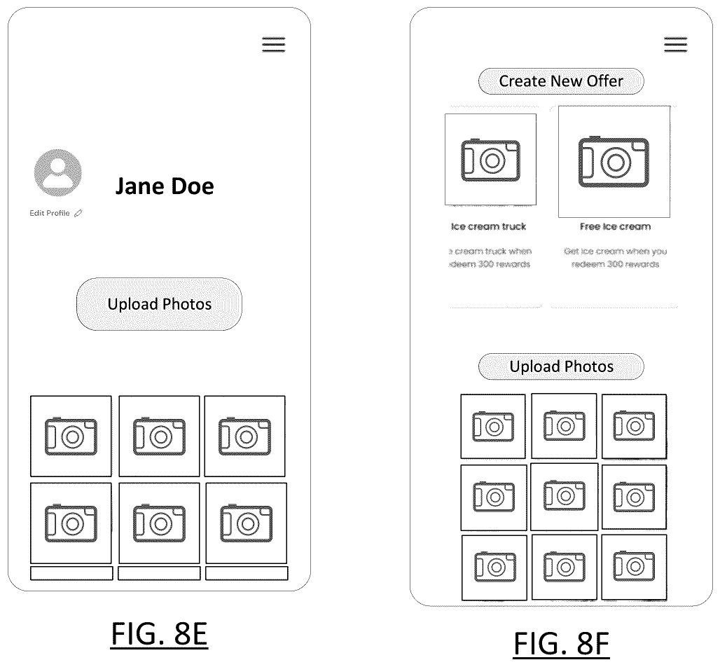

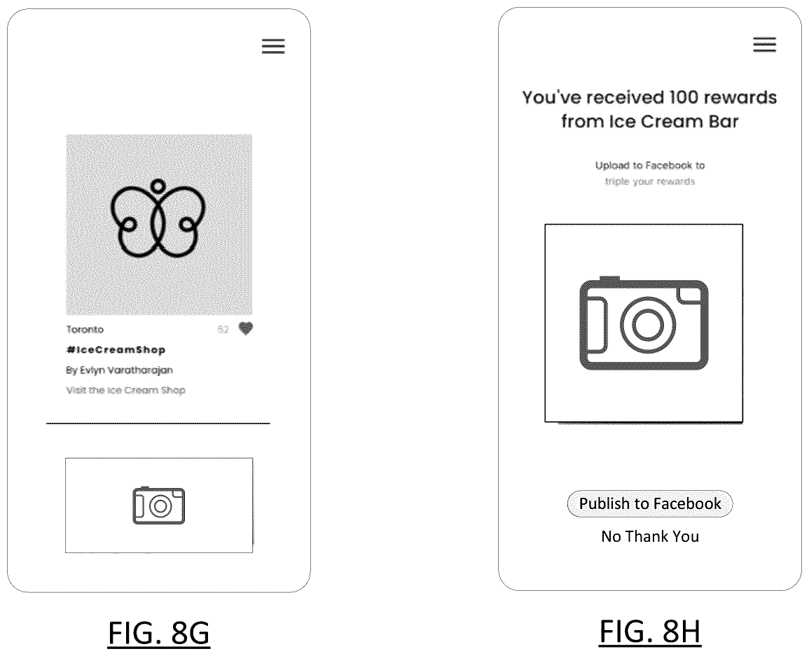

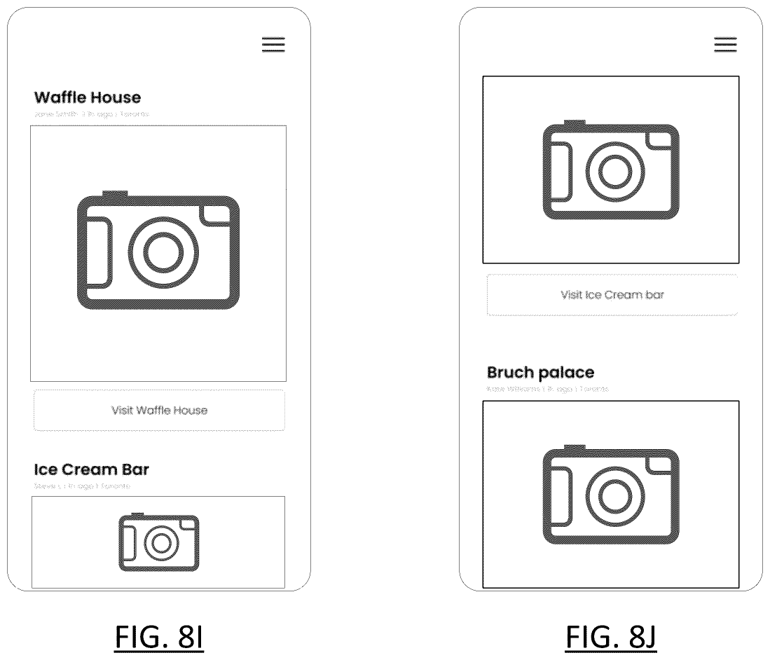

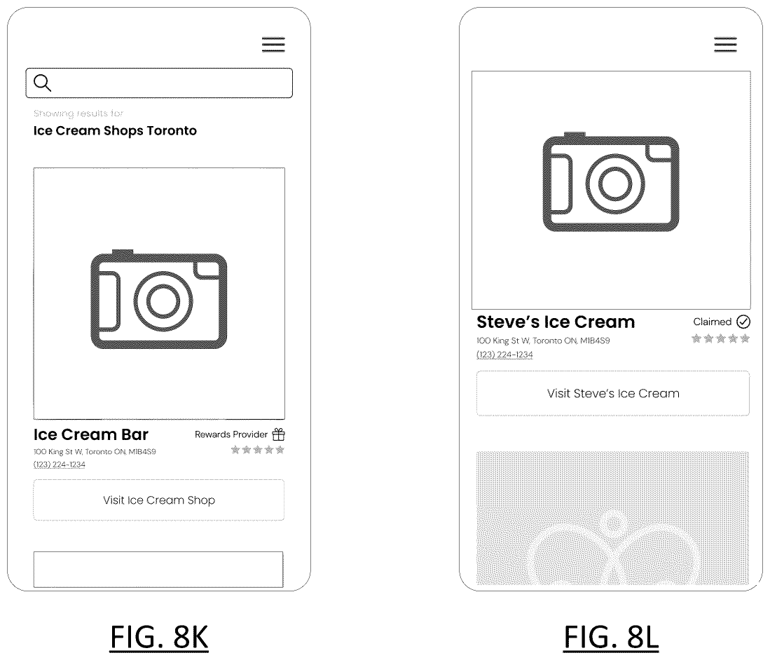

Reference is made to FIGS. 8A to 8L which show pages of a graphical user interface (GUI) of an example application which may be used for accessing a digital resource platform, in accordance with embodiments of the present disclosure. FIGS. 8A to 8B illustrate pages that a merchant may use to define parameters for a digital resource transfer/allocation to a user. The merchant can input a quantity of digital resources (e.g., 100) to transfer to a recipient (identified by a phone number), and confirm the transfer.

A user, e.g., a customer of the merchant, may be presented with a page such as that shown in FIG. 8C, notifying the user that they have collected digital resources from the merchant. The user can log in to their account on the digital resource platform to claim and finalize collection of the digital resources. FIG. 8D shows a page in which the user can upload multimedia (e.g., photo, video, etc.) to double the quantity of digital rewards that are collected by the user.

FIGS. 8E to 8F illustrate example profile pages of a user (e.g., a merchant, customer, etc.) of the digital resource platform. In particular, the profile pages may display a web feed that is personalized to each user of the digital resource platform based on various factors such as account privacy setting, access privileges for uploaded content items, etc. FIG. 8G shows an example listing of a business on a web feed of a user of the digital resource platform.

FIG. 8H is an example page which allows a user that collects digital resources from a merchant to triple (or otherwise further increase) the quantity of resources collected. The further increase can be triggered by the user sharing multimedia objects pertaining to their interaction with the merchant issuing the digital resources on one or more social media accounts of the user.

FIGS. 8I and 8J show an example web feed that lists a plurality of businesses. The list comprises selectable listing associated with merchants that are on the digital resource platform, e.g., merchants with or without active accounts on the platform.

FIGS. 8K and 8L illustrate an example display of search results for a search query. As described herein, the search results on the digital resource platform may be displayed in accordance with a display order that prioritizes merchant information of merchants that administer an active loyalty program on the digital resource platform.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a sub-combination of features which may not be explicitly described above.

In addition, features from one or more of the above-described example implementations may be selected and combined to create alternative example implementations including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
receiving, via a first computing device, a first request to process an initial allocation of a first quantity of digital resources to a resource account;
providing, to a second computing device associated with the resource account, an indication of a first user action that is required for gaining access to a second quantity of the digital resources, the first user action comprising an upload, via the second computing device, of multimedia data to the computing system;
receiving, via the second computing device, a second request to access the second quantity of the digital resources, the second request including at least one multimedia object;
in response to determining that the at least one multimedia object satisfies defined criteria:
causing the second quantity of the digital resources to be allocated to the resource account; and
providing, to the second computing device, an indication of a second user action in connection with the at least one multimedia object that is required for gaining access to a third quantity of the digital resources.

2. The method of claim 1, further comprising causing the first quantity of digital resources to be allocated to the resource account and wherein the indication of the first user action is provided to the second computing device in response to detecting completion of the initial allocation.

3. The method of claim 1, wherein the defined criteria relate to multimedia object type and wherein the method further comprises determining that an object type associated with the at least one multimedia object is an image or a video.

4. The method of claim 1, further comprising providing, via a graphical user interface on the second computing device, a multimedia input request for prompting user input of a selection of a multimedia object to upload to the computing system.

5. The method of claim 1, wherein providing the indication of the first user action comprises causing display, via a graphical user interface on the second computing device, of at least one user interface element that is selectable for initiating the first user action.

6. The method of claim 1, further comprising:
generating a unique first token associated with the initial allocation of the first quantity of digital resources to the resource account;
providing, to the second computing device, the first token; and
validating the second request based on confirming that the second request is associated with the first token.

7. The method of claim 1, wherein the second user action comprises:
a user input of a request to upload, via the second computing device, the at least one multimedia object to a user account associated with the second computing device at a social networking server; or
sharing a link associated with the upload to the user account at the social networking server.

8. The method of claim 7, further comprising:
determining that the second user action has been initiated; and
in response to determining that the second user action has been initiated, causing the third quantity of the digital resources to be allocated to the resource account.

9. The method of claim 7, wherein the uploaded multimedia object or a graphical representation of the upload link includes a watermark comprising at least one of a merchant's name or a hashtag of the merchant's name.

10. The method of claim 1, further comprising causing display, via a graphical user interface on the second computing device, of the at least one multimedia object in association with a public user account.

11. The method of claim 1, further comprising causing display, via a graphical user interface on the first computing device, of the at least one multimedia object in association with a merchant account.

12. A computer-implemented method, comprising:
receiving, via a first computing device, a first request to display a news feed associated with a digital resource platform;
obtaining historical multimedia upload data associated with one or more merchants, the historical multimedia upload data including multimedia objects previously uploaded to the digital resource platform by at least one user in exchange for an allocation of digital resources to a first user account associated with the at least one user on the digital resource platform;
causing to be displayed, via the first computing device, the news feed including one or more of the multimedia objects;
receiving, via a second computing device, a new upload of multimedia data to the digital resource platform in exchange for an allocation of digital resources to a second user account associated with the second computing device; and
causing to be displayed, via the first computing device, an updated news feed based on the new upload of multimedia data.

13. The method of claim 12, wherein the multimedia objects comprise images or videos that are associated with at least one merchant having a merchant account on the digital resource platform.

14. The method of claim 12, wherein the multimedia objects comprise images or videos previously uploaded by the at least one user in exchange for the allocation of digital resources to the first user account.

15. The method of claim 12, further comprising determining a feed type associated with the first request, wherein causing the updated news feed to be displayed comprises determining those of the previously uploaded multimedia objects that are available for displaying on news feeds of the feed type.

16. The method of claim 12, wherein causing the updated news feed to be displayed comprises determining preference data of a user account associated with the first request and identifying multimedia objects for display on the news feed based on the preference data.

17. The method of claim 12, wherein causing the updated news feed to be displayed comprises determining user engagement data of a user account associated with the first request and identifying multimedia objects for display on the news feed based on the user engagement data.

18. The method of claim 12, further comprising:
identifying a user account associated with the first request;
determining, based on preference data associated with the user account, recommendations of one or more of the multimedia objects; and
providing, to the first computing device, display data for the news feed comprising the recommendations of the multimedia objects.

19. The method of claim 18, wherein the display data for the news feed further comprises promotional data of products associated with a plurality of merchants on the digital resource platform.

20. The method of claim 18, wherein the recommendations of the one or more of the multimedia objects are determined based on rewards earned history associated with the user account.

21. The method of claim 12, wherein the recommendations of the one or more of the multimedia objects are determined based on user engagement data associated with the user account.

22. A computer-implemented method, comprising:
receiving, via a computing device, a search query;
obtaining a set of one or more search results based on performing a search of a database using the search query;
determining a display order of displaying the one or more search results, wherein the determining comprises:
identifying a first subset of search results that are associated with merchant accounts on a digital resource platform having respective digital resource allocation program enabled; and
setting the display order such that the first subset of search results is displayed with higher priority than search results that are not included in the first subset; and
causing the one or more search results to be displayed via the computing device in accordance with the display order.

23. The method of claim 22, wherein determining the display order comprises:
identifying a second subset of search results that are associated with merchant accounts on the digital resource platform that do not have a respective digital resource allocation program enabled; and
setting the display order such that the second subset of search results is displayed with higher priority than search results that are not included in the first subset or the second subset and lower priority than search results included in the first subset.

24. The method of claim 22, wherein causing the one or more search results to be displayed in accordance with the display order comprises causing the computing device to display, on a search user interface, search results associated with higher priority before displaying search results associated with lower priority based on the display order.

25. The method of claim 22, wherein the one or more search results comprise merchant information associated with the merchant accounts.

26. The method of claim 22, wherein at least one of the search results comprises a link that is associated with a profile page of a corresponding merchant account.

27. The method of claim 22, wherein the search results of the first subset are displayed in a random order or in accordance with defined display criteria.

28. The method of claim 23, wherein the search results of the second subset are displayed in a random order or in accordance with defined display criteria.
